(19) United States
(12) Patent Application Publication
(10) Pub. No.: US 2012/0274207 A1
(43) Pub. Date: Nov. 1, 2012

(54) LAMP

(76) Inventor: Barry Preston, Melton Mowbray (GB)

(21) Appl. No.: 13/515,396

(22) PCT Filed: Dec. 16, 2010
(86) PCT No.: PCT/GB10/02287

§ 371 Date: Jul. 18, 2012

(30) Foreign Application Priority Data
Dec. 17, 2009 (GB) 0922076.5

(51) Int. Cl. H01J 61/30; H01J 61/36

(52) U.S. Cl. 313/623

(57) ABSTRACT

A thick-walled electroded lamp (11) has molybdenum cup seals (10) attached to both ends. The seals have tungsten electrodes (14) extending into the void (15) formed by the bore of the thick walled tube. Further the seals comprise molybdenum cups (16) having feather edges (17) set in the ends of short thin wall quartz tubes (18) fused to the ends of the thick walled quartz tube (12). The electrodes are brazed to the cups at joints (19). The lamp can be filled with its noble gas and metal halide charge, or other excitable material fill through an auxiliary exhaust tube (20) attached just in front of the cupped seal.

The present invention relates to an electroded discharge lamp.

It is known to excite a discharge in a capsule with a view to producing light. A typical example is a fluorescent tube lamp, which uses mercury vapour. This is excitable to produce ultraviolet radiation. In turn, this excites fluorescent powder to produce light. Many discharge lamps such as sodium discharge lamps produce visible light directly, at the particular discharge frequency of the excitable material used. Such lamps are more efficient in terms of lumens of light emitted per watt of electricity consumed than tungsten filament lamps. However, they still suffer the disadvantage of requiring electrodes within the capsule to excite the discharge. Since these carry the current required for the discharge, they degrade and ultimately fail.

In a development programme of electrodeless bulb lamps, we have developed the lamps shown in our patent application Nos. PCT/GB2006/002018 entitled “Lamp” (our “'2018 lamp”), PCT/GB2005/005080 for a bulb for the lamp and PCT/GB2007/001935 for a matching circuit for a microwave-powered lamp. These all relate to lamps operating electrodelessly by use of microwave energy to stimulate light emitting plasma in the bulbs. Our '2018 lamp uses a dielectric wave-guide, which substantially reduces the wave length at the operating frequency of 2.4 Ghz. This lamp is suitable for use in domestic appliances such as rear projection television.

U.S. Pat. No 6,737,809 describes a light source to be powered by microwave energy, the source having:
a body having a sealed void therein,
a microwave-enclosing Faraday cage surrounding the body,
the body and the cavity defining a resonant waveguide,
a fill in the void of material excitable by microwave energy to form a light emitting plasma therein, and
an antenna arranged within the body for transmitting plasma-inducing, microwave energy to the fill, the antenna having:
a connection extending outside the body for coupling to a source of microwave energy.

In pursuing our programme, we coalesced the bulb and the waveguide into a single component, as described in our International patent application No PCT/GB2008/003829, dated 14 Nov. 2008 and now published under No WO2009/063205. In the latter, we described and claimed (as amended during International examination), a light source to be powered by microwave energy, the source having:
a body having a sealed void therein,
a microwave-enclosing Faraday cage surrounding the body,
the body within the Faraday cage being a resonant waveguide,
a fill in the void of material excitable by microwave energy to form a light emitting plasma therein, and
an antenna arranged within the body for transmitting plasma-inducing, microwave energy to the fill, the antenna having:
a connection extending outside the body for coupling to a source of microwave energy;
   wherein:
the body is a solid plasma crucible of material which is lucent for exit of light therefrom, and
the Faraday cage is at least partially light transmitting for light exit from the plasma crucible,
   the arrangement being such that light from a plasma in the void can pass through the plasma crucible and radiate from it via the cage.

We call this light source a Light Emitting Resonator (LER)

As used in the LER specification (WO2009/063205):

“lucent” means that the material, of which the item described as lucent, is transparent or translucent;

“plasma crucible” means a closed body enclosing a plasma, the latter being in the void when the latter's fill is excited by microwave energy from the antenna.

In our LER lamp the plasma is driven at high power. A thin walled electroded lamp, of the same internal dimensions, operating at such high power would be likely to fail because the inner wall temperature would be too high. Typically LER plasma chambers are operated at wall loadings of greater than 50 W.cm⁻². Conventional fused silica arc tubes for general lighting service are operated at less than 25 W.cm⁻². Wall loading is defined as the total power dissipated in the LER lamp divided by the internal surface area of the plasma chamber. We believe that this high wall loading is possible due to the LER lamp's ability to dissipate heat. Heat is conducted away from close to the plasma chamber and dissipated from a relatively large surface area by both radiation and convection. The convection can be forced or natural.

We now believe that a thick walled electroded lamp can be operated at the same order of power as the LER, with an excitable-material filling void also of the same order of magnitude as the LER.

The object of the present invention is to provide an improved light source.

According to the invention there is provided an electroded lamp comprising:
a lucent crucible having a sealed void therein,
a pair of electrodes carried by the crucible at opposite ends of the void and extending into the void and
a fill in the void of material excitable by electric current passing between the electrodes to form a light emitting plasma therein;
   wherein:
the lucent crucible has a wall thickness at least as great as double the cross-sectional dimension of the void in the direction of the thickness.

The arrangement is such that in use:
light from a plasma in the void can pass through the plasma crucible and radiate from it and
heat from the plasma can be conducted from the void to the surface of the crucible for dissipation therefrom to maintain a stable operating temperature of the crucible.

It is anticipated that much of the heat will be dissipated from the surface of the crucible by convection, and also much of it will be dissipated by radiation.

Further, we expect heat to be radiated from the internal material of the crucible, especially close to the void. At present we know of no means for measuring whence precisely radiated heat is originating; that is to say, considering the crucible to be made up of successively larger incremental cylinders or skins, how much heat is radiated from each cylinder or skin. We do however believe that our thick wall lamps do dissipate a significant proportion of their heat by radiation from the crucible material close to the void.

In our LER lamp, typically the ratio of outer diameter to the diameter of the void is greater than a factor of 5. This results from the crucible being sized as a resonant cavity, in other words the dimensions of crucible are a function of the microwave drive frequency.

In the present invention, we could use such a ratio of void to crucible size, but do not expect such a large ratio to be necessary. Indeed, we expect the cross-sectional dimension of the crucible to be too small for microwave resonance. Nevertheless the cross-sectional dimension is substantially larger than of conventional lamps for a given void cross-section.

The void within the lucent crucible can be sealed about the electrodes
by pressed or pinched seal or
by vacuum collapsed seal or
by cup seal or
by graded glass seal.

Preferably, a strip of molybdenum, or any material with a similar low coefficient of thermal expansion and high electrical conductivity, extends through the seal in the crucible and electrically connects the electrodes to outside of the crucible.

Preferably, a sealable exhaust tube is provided for the introduction of material excitable by electric current into the void in the lucent crucible.

To help understanding of the invention, a specific embodiment thereof will now be described by way of example and with reference to the accompanying drawings, in which:

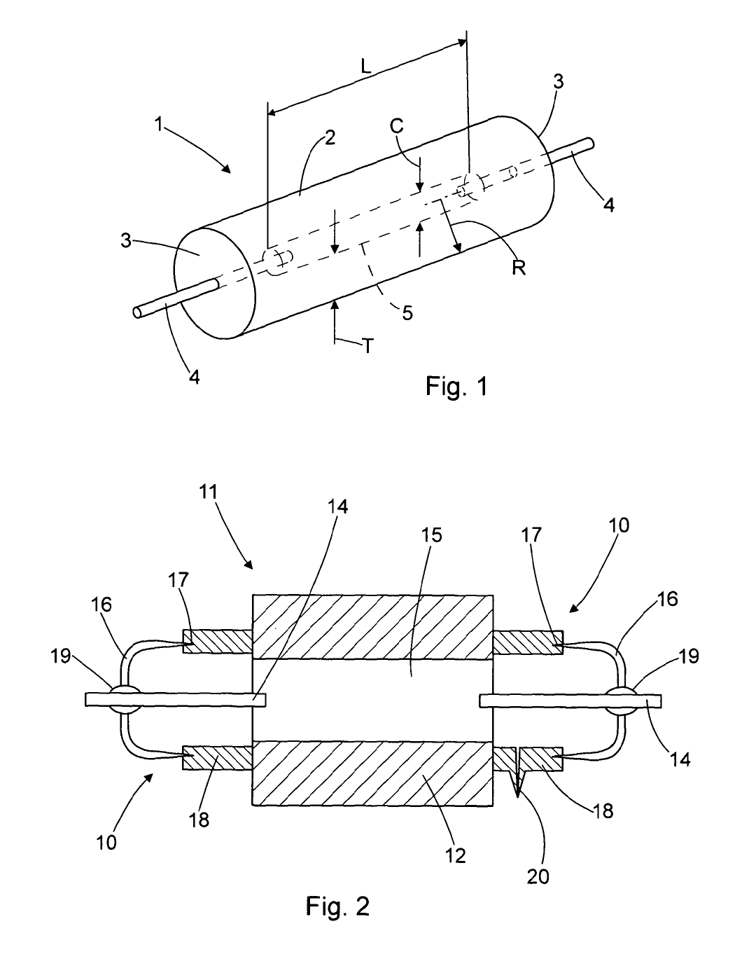

FIG. 1 is a perspective view of a first lamp of the invention; and

FIG. 2 is a central cross-sectional view of a second lamp of the invention.

Referring first to FIG. 1, a lamp 1 has a lucent crucible 2 of thick walled quartz tube. The ends 3 of the tube are closed and include tungsten electrodes 4. Within the crucible, a void 5 is defined. The tube has a bore 5 mm bore and a 10 mm wall thickness T. Thus the void has a 5 mm transverse cross-section C and a length L of 12 mm. The void is filled with excitable material, typically a metal halide and a rare earth gas. The actual fill will be chosen in accordance with the spectrum of the light to be emitted.

For comparative purposes, the outside surface area of the tube corresponding to the length of the void is

2πRL

R being radius of the tube and L being the length of the void. For the lamp of FIG. 1, the surface area is

2×π×12.5×12=942.48 mm².

Assuming that the convective and radiant heat loss from the surface is proportional only to this surface area, a conventional thin walled, electroded lamp having an equivalent surface area would for a wall thickness of 1 mm have a length of

12×12.5/3.5=42.86 mm.

In other words by increasing the wall thickness to produce a thick-walled lamp, the length has been reduced by more than a factor of three. This in turn has significant benefits in terms of focusing the emitted light for its use in a luminaire. It is known that optical systems are more efficient when the light source that the system is controlling is close to a point source. It will be seen by this comparison that the exemplified lamp of the invention produces light over a considerably shorter length, whereby luminaire efficiency is markedly increased. Indeed we would expect that such increase in efficiency can result in reduction of the number of luminaires, even to the extent of halving their number. In turn this halves not only the operating cost, but also the capital cost.

The electrodes can be incorporated in the lamp in any of a number of conventional manners, known to the skilled addressee of this specification. Accordingly, one embodiment only will be described.

Referring on to FIG. 2, a thick-walled lamp 11 has molybdenum cup seals 10 attached to both ends. The seals have tungsten electrodes 14 extending into the void 15 formed by the bore of the thick walled tube. Further the seals comprise molybdenum cups 16 having feather edges 17 set in the ends of short thin wall quartz tubes 18 fused to the ends of the thick walled quartz tube 12. The electrodes are brazed to the cups at joints 19. The lamp can be filled with its noble gas and metal halide charge, or other excitable material fill through an auxiliary exhaust tube 20 attached just in front of the cupped seal.

It is anticipated that for high powers, the diameter of the thick wall tube can be increased above double the bore of the void.

The lamp can be driven in any conventional manner including being driven off mains voltage with a choke in series.

1. An electroded lamp having:
a lucent crucible having a sealed void therein,
a pair of electrodes carried by the crucible at opposite ends of the void and extending into the void; and
a fill in the void of material excitable by electric current passing between the electrodes to form a light emitting plasma therein;
wherein:
the lucent crucible has a wall thickness at least as great as double the cross-sectional dimension of the void in the direction of the thickness.

2. An electroded lamp as claimed in claim 1, wherein the void within the lucent crucible is sealed about the electrodes by pressed or pinched seal.

3. An electroded lamp as claimed in claim 1, wherein the void within the lucent crucible is sealed about the electrodes by vacuum collapsed seal.

4. An electroded lamp as claimed in claim 1, wherein the void within the lucent crucible is sealed about the electrodes by cup seal.

5. An electroded lamp as claimed in claim 1, wherein the void within the lucent crucible is sealed about the electrodes by graded glass seal.

6. An electroded lamp as in claim 1, wherein a strip of molybdenum, or any material with a similar low coefficient of thermal expansion and high electrical conductivity, extends through the seal in the crucible and electrically connects the electrodes to outside of the crucible.

7. An electroded lamp as in claim 1, wherein a sealable exhaust tube is provided for the introduction of material excitable by electric current into the void in the lucent crucible.
